(19) United States
(12) Patent Application Publication
(10) Pub. No.: US 2025/0087801 A1
(43) Pub. Date: Mar. 13, 2025

(54) MECHANICALLY CONNECTED CELL-TO-CELL ENERGY STORAGE ARRAY

(71) Applicant: GM GLOBAL TECHNOLOGY OPERATIONS LLC, Detroit, MI (US)

(72) Inventors: Derek F. Lahr, Howell, MI (US); Arun M. Joshi, Troy, MI (US); Liang Xi, Northville, MI (US); Francis A. Carpenter, Milan, MI (US); Matthew Simonin, Ortonville, MI (US); Qaiser Khan, Novi, MI (US); SriLakshmi Katar, Troy, MI (US); Jung Woo Seo, Troy, MI (US); Ryan J. Prescott, Burton, MI (US)

(73) Assignee: GM GLOBAL TECHNOLOGY OPERATIONS LLC, Detroit, MI (US)

(21) Appl. No.: 18/466,081

(22) Filed: Sep. 13, 2023

(51) Int. Cl. H01M 50/209; H01M 10/48

(52) U.S. Cl. CPC H01M 50/209; H01M 10/482; H01M 2220/20

(57) ABSTRACT

A modular multi-cell rechargeable energy storage system (RESS) includes a RESS enclosure surrounded by an external environment and having an enclosure tray, an enclosure cover, and a rail structure. The RESS also includes a plurality of mechanically interconnected battery cell blocks arranged in the RESS enclosure. Each battery cell block includes a cell case having at least one interface connector configured to couple the cell case to the rail structure, such that each battery cell block is engaged with and aligned and supported by the rail structure.

### INTRODUCTION

The present disclosure relates to a mechanically connected cell-to-cell array for a multi-cell rechargeable energy storage system.

Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries. A multi-cell rechargeable energy storage system (RESS) typically includes a battery cell array, such as a battery module, pack, etc., plurality of secondary battery cells in relatively close proximity to one another.

A large RESS may be used to store electrical energy for future use and as a buffer between peak power generation and peak system loads, such as in stationary energy storage systems and electric vehicles (EVs). To meet design objectives of charging rates, peak output power, and capacity, secondary batteries may be organized into battery systems or arrays with battery cells connected in parallel and/or in series and enclosed into battery module and/or pack housings. Such an RESS typically includes an enclosure for housing individual battery cells, and various internal components, such as a cold plate, thermal insulation elements, an interconnect board (ICB) for linking the battery cells, sensing and communication components, and an electrical busbar establishing connections therebetween.

### SUMMARY

A modular multi-cell rechargeable energy storage system (RESS) includes a RESS enclosure surrounded by an external environment and having an enclosure tray, an enclosure cover, and a rail structure. The RESS also includes a plurality of mechanically interconnected battery cell blocks arranged in the RESS enclosure. Each battery cell block includes a cell case having at least one interface connector configured to couple the cell case to the rail structure, such that each battery cell block is engaged with and aligned and supported by the rail structure.

The rail structure may be mounted to the enclosure tray and/or to the enclosure cover.

The rail structure may include a plurality of parallel guide rails.

The interface connector(s) may be configured to slidably engage the parallel guide rails.

Each interface connector may have a U-shaped, C-shaped, or L-shaped cross-section configured to engage the parallel guide rails.

In a cross-sectional view, each of the parallel guide rails may have a convex rail surface.

In a cross-sectional view, each of the parallel guide rails may have a concave rail surface.

Each interface connector may be a protrusion configured to slidably engage the concave rail surface of one of the parallel guide rails.

The protrusion may be configured to snap into the concave rail surface.

Each interface connector may have one of an integrally formed feature of the cell case and a bracket affixed thereto.

Each battery cell block may additionally include interlocking flanges mounted to the cell case and configured to interconnect adjacent cell blocks. At least one of the interlocking flanges of each battery cell block may incorporate the interface connector to couple the cell case to the rail structure.

Each battery cell block may be one of a prismatic and a cylindrical cell.

The RESS enclosure may be part of, i.e., integrated into, a vehicle body structure.

A motor vehicle having a power-source and the above-disclosed modular RESS configured to supply electric energy to the power-source is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a modular multi-cell rechargeable energy storage system (RESS) configured to generate and store electrical energy, according to the present disclosure.

FIG. 2 is a schematic side view of a battery cell array enclosure having a rail structure employed for the RESS shown in FIG. 1, illustrating the array enclosure having an enclosure tray and an enclosure cover serving as a floor pan section of the vehicle body structure, according to the present disclosure.

FIG. 3 is a schematic exploded perspective view of the RESS shown in FIG. 1 arranged inside the RESS enclosure shown in FIG. 2, illustrating a plurality of battery cell blocks arranged in individual modules and engaged with the rail structure.

FIG. 4 is a schematic side view of battery cell blocks interconnected to form the RESS shown in FIGS. 1 and 3, according to the present disclosure.

FIG. 5A is a schematic partial cross-sectional front view of a battery cell block having a U-shaped embodiment of the interface connector engaged with the rail structure shown in FIG. 2, according to the present disclosure.

FIG. 5B is a schematic partial cross-sectional front view of a battery cell block having an L-shaped embodiment of the interface connector engaged with the rail structure shown in FIG. 2, according to the present disclosure.

FIG. 5C is a schematic partial cross-sectional front view of a battery cell block having a protrusion embodiment of the interface connector engaged with the rail structure shown in FIG. 2, according to the present disclosure.

FIG. 5D is a schematic partial cross-sectional front view of a battery cell block having another embodiment of the interface connector engaged with the rail structure shown in FIG. 2, according to the present disclosure.

FIG. 5E is a schematic top view of a group of battery cell blocks with interlocking flanges incorporating interface connectors for engage the rail structure shown in FIG. 2, according to the present disclosure.

### DETAILED DESCRIPTION

Those having ordinary skill in the art will recognize that terms such as “above”, “below”. “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of a number of hardware, software, and/or firmware components configured to perform the specified functions.

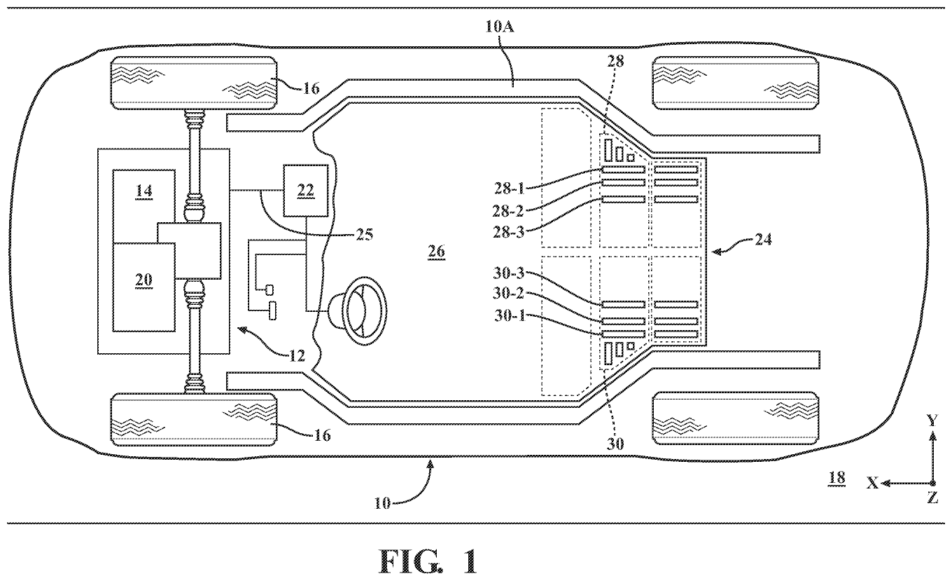

Referring to FIG. 1, a motor vehicle 10 having a powertrain 12 is depicted. Vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. As shown in FIG. 1, the motor vehicle 10 also includes a vehicle body structure 10A configured to support the powertrain 12 as well vehicle passenger and cargo compartments (not shown). The powertrain 12 includes a power-source 14 configured to generate a power-source torque for propulsion of the vehicle 10 via driven wheels 16 relative to a road surface 18. The power-source 14 is depicted as an electric motor-generator; consequently, the motor vehicle 10 may be identified as an electric vehicle (EV).

As shown in FIG. 1, the powertrain 12 may also include an additional power-source 20, such as an internal combustion engine. The power-sources 14 and 20 may act in concert to power the motor vehicle 10. The motor vehicle 10 additionally includes an electronic controller 22 and a modular multi-cell rechargeable energy storage system (RESS) 24 configured to generate and store electrical energy through heat-producing electro-chemical reactions for supplying the electrical energy to the power-sources 14 and 20. In the instant disclosure, the RESS 24 is defined as “modular” due to the system being constructed from interlocking battery cell blocks, as will be described in detail below. The electronic controller 22 may be a central processing unit (CPU) that regulates various functions of the vehicle 10, including the power-sources 14 and 20, or as a powertrain control module (PCM) configured to control the powertrain 12 to generate a predetermined amount of power-source torque.

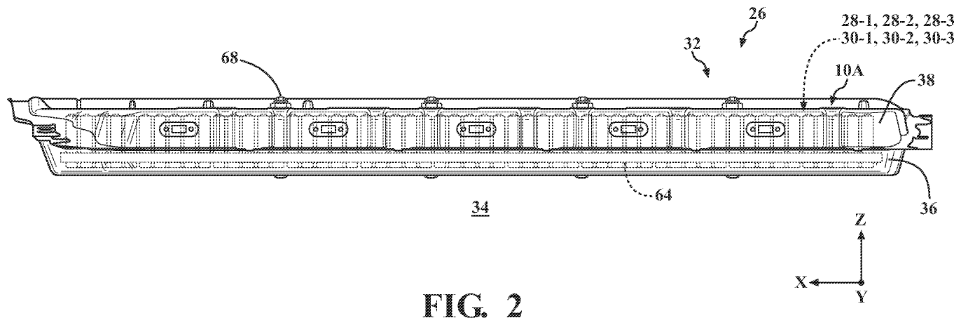

The modular RESS 24 may be connected to the power-sources 14 and 20, the electronic controller 22, as well as other vehicle systems via a high-voltage BUS 25. Although the RESS 24 is described herein primarily with respect to a motor vehicle environment, nothing precludes the subject RESS from being employed for powering other, non-automotive or stationary systems. The vehicle body structure 10A may incorporate the modular RESS 24 as an integral part thereof (shown in FIG. 2). As a result, in the motor vehicle 10, the RESS 24 may bear at least some structural and/or dynamic loads experienced by the body structure during vehicle operation. The RESS 24 includes one or more sections or arrays 26 of individual battery cells arranged with respect to an X-Y-Z coordinate system. Each battery cell array 26 may be configured as a battery module or a number of battery modules bundled into a battery pack.

With resumed reference to FIG. 1, the array 26 includes a plurality of interlocking battery cell blocks, such as a first group of battery cell blocks 28 and a neighboring, directly adjacent, second group of battery cell blocks 30, each extending generally upward, i.e., in the Z-direction. Although one array 26 (illustrated as a battery pack) and two groups of battery cell blocks 28, 30 (illustrated as individual modules) are specifically indicated, nothing precludes the RESS 24 from having a greater number of such arrays with a particular number of battery cell blocks arranged therein. As shown, the first cell group 28 includes individual battery cell blocks 28-1, 28-2, 28-3, while the neighboring second cell group 30 includes individual battery cell blocks 30-1, 30-2, 30-3. Individual battery cells in groups 28 and 30 may be prismatic or cylindrically shaped, a.k.a., cylindrical cell blocks.

As shown in FIG. 2, the RESS 24 also includes a RESS housing or enclosure 32 configured to accommodate and retain each of the first and second battery cell groups 28, 30. The RESS enclosure 32 is surrounded by an ambient environment 34, i.e., environment external to the RESS enclosure, and configured to bear at least some structural and/or dynamic loads experienced by the vehicle body structure 10A. The RESS enclosure 32 is configured to manage high-temperature gases emitted by battery cells in the cell groups 28, 30, such as during a battery cell thermal runaway event, and expel the high-temperature gases to the external environment 34. The RESS enclosure 32 includes an enclosure tray 36 and an enclosure cover 38. The enclosure cover 38 is generally positioned above the battery cell blocks 28-1, 28-2, 28-3 and 30-1, 30-2, 30-3 and may additionally serve as a floor pan section of the vehicle body structure 10A (shown in FIG. 2).

The enclosure cover 38 is configured to engage the enclosure tray 36 to substantially seal the RESS enclosure 32 and its contents from the external environment 34. As shown in FIG. 2, in the motor vehicle 10, the RESS enclosure 32 is arranged in a horizontal X-Y plane, such that the enclosure cover 38 is positioned above the enclosure tray 36 when viewed along a Z-axis. The battery cell blocks 28-1, 28-2, 28-3, 30-1, 30-2, 30-3 may be arranged parallel to each other in their respective cell groups 28 and 30 within the RESS enclosure 32. Alternatively, some of the battery cell blocks may be arranged perpendicular relative to adjacent cell blocks in the cell array 26 to adapt the general shape of the modular RESS 24 to the space available inside the boundaries of the vehicle body structure 10A.

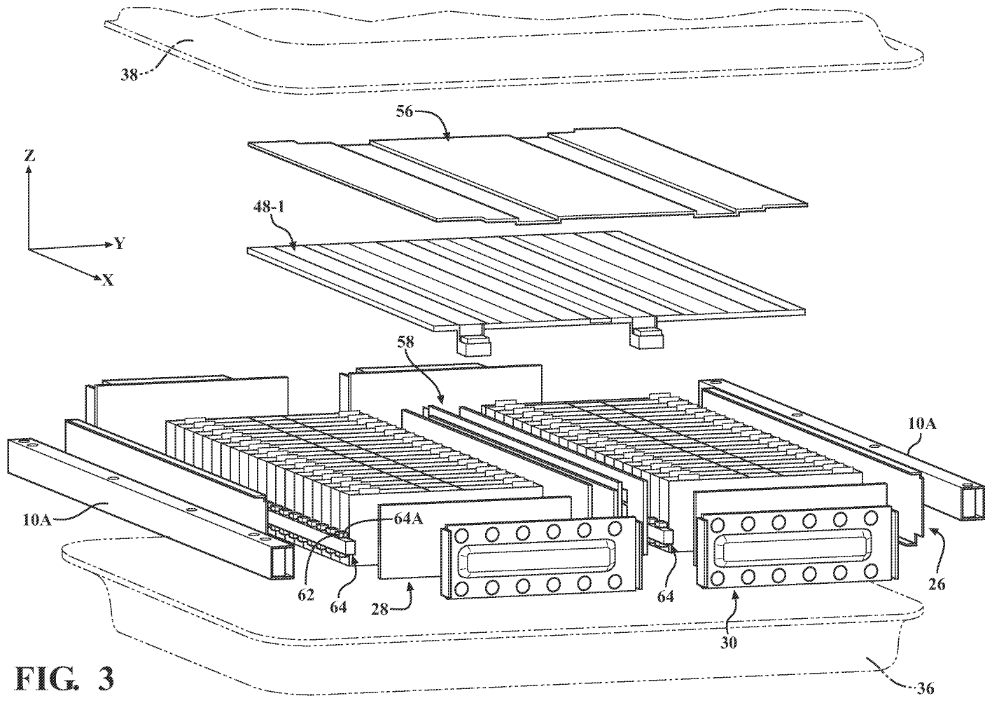

As shown in FIG. 3, each battery cell block 28-1, 28-2, 28-3, 30-1, 30-2, and 30-3 includes a cell case 40 defining a cell vent 40A and enclosing battery cell electrodes, electrolyte, and other related components (not shown). Each interlocking battery cell block in cell groups 28 and 30 also includes one or more electrically insulated structural connectors 42 configured to firmly link or interconnect the cell case 40 with a cell case of an adjacent battery cell block. A battery cell group generated by such interconnected battery cell blocks in turn enhances structural rigidity of the RESS 24. Each battery cell block 28-1, 28-2, 28-3, 30-1, 30-2, 30-3 additionally includes a thermal mitigation barrier (TMB) segment 44 fixed to the cell case 40. The subject TMB segment 44 is arranged on a particular side of the cell case 40, such that, when the RESS 24 is assembled, the TMB segment is disposed in contact with or pressed against an adjacent battery cell block, and, as a result, at least one TMB segment is sandwiched between a pair of adjacent battery cell blocks.

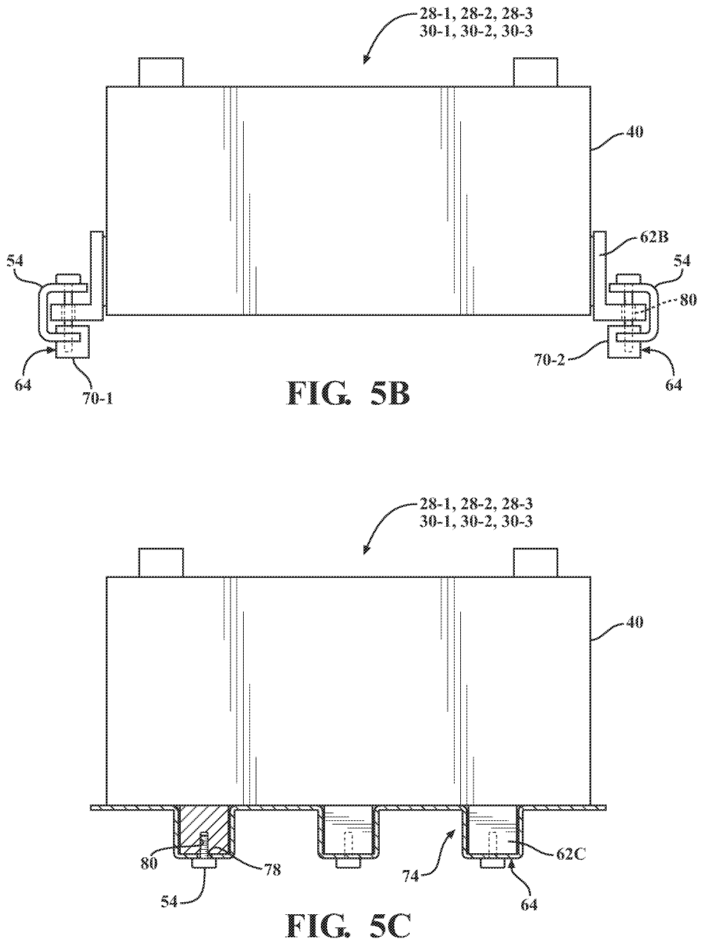

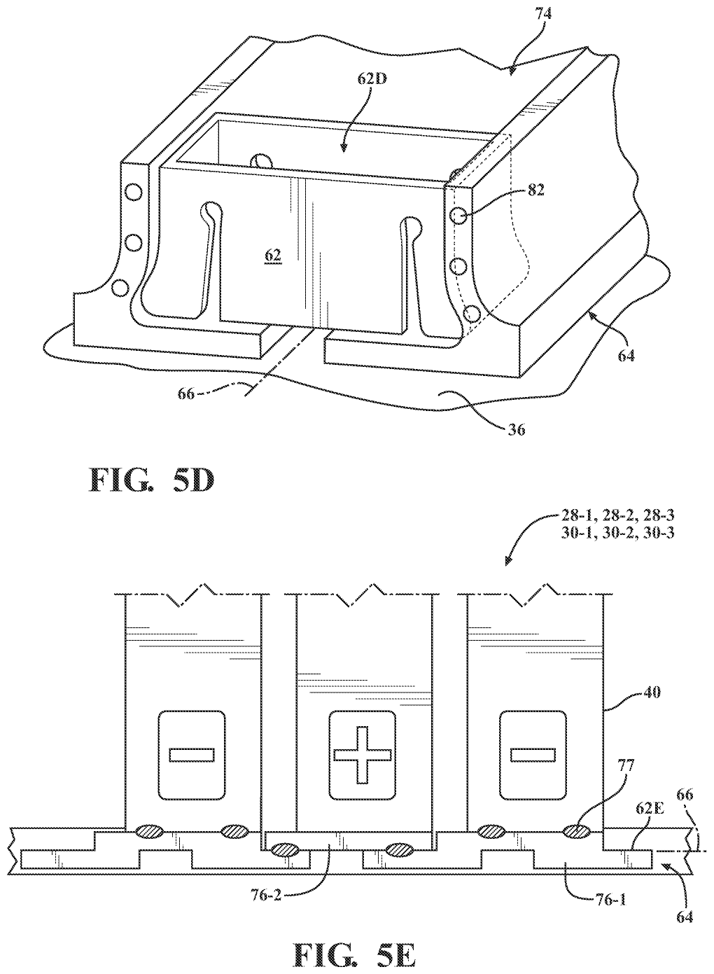

As also shown in FIG. 3, the cell blocks in each of the first and second cell groups 28, 30 are operatively/functionally and mechanically interconnected. Each battery cell block 28-1, 28-2, 28-3, 30-1, 30-2, 30-3 may include modularly connectable elements or components for generating a working battery chain. Such elements may include a thermal insulator 46, bus bar segment 48, cold plate segment 50, and thermal interface material (TIM) segment 52, permitting construction of cell groups or modules having desired scale. When the battery cell blocks in cell groups 28 and 30 are interconnected, as shown in FIGS. 3 and 5, individual bus bar segments 48 plug into a busbar subassembly 48-1 (shown in FIG. 3) disposed within the RESS enclosure 32. The busbar subassembly 48-1 is configured to electrically connect and transmit electrical signals to and from the battery cell blocks in the array 26. The RESS 24 may also include various sensing devices (such as thermistors, fuses, etc.), which, although not specifically shown, are understood to detect operation of cell groups 28, 30 or individual battery cell blocks in the array 26.

Also, when the battery cell blocks in cell groups 28 and 30 are interconnected, as shown in FIGS. 3 and 5, the cold plate segments 50 of the constituent battery cell blocks form a cold plate subassembly 50-1. The resultant cold plate subassembly 50-1 is positioned to absorb thermal energy from the subject battery cell blocks and maintain requisite RESS 24 operating conditions. The interlocked battery cell blocks 28-1, 28-2, 28-3, 30-1, 30-2, 30-3 may be fixed to the RESS enclosure 32 by one or more fasteners 54, as will be described in detail below. The RESS 24 may also include a mica cover sheet 56 arranged between the enclosure cover 38 and the battery cell array 26 and a mid-plate 58 with an electrically insulating foam element sandwiched between structural adhesive layers. The mid-plate 58 with the structural adhesive layers may be arranged between individual modules, e.g., 28 and 30, and provide thermal and electrical isolation therebetween.

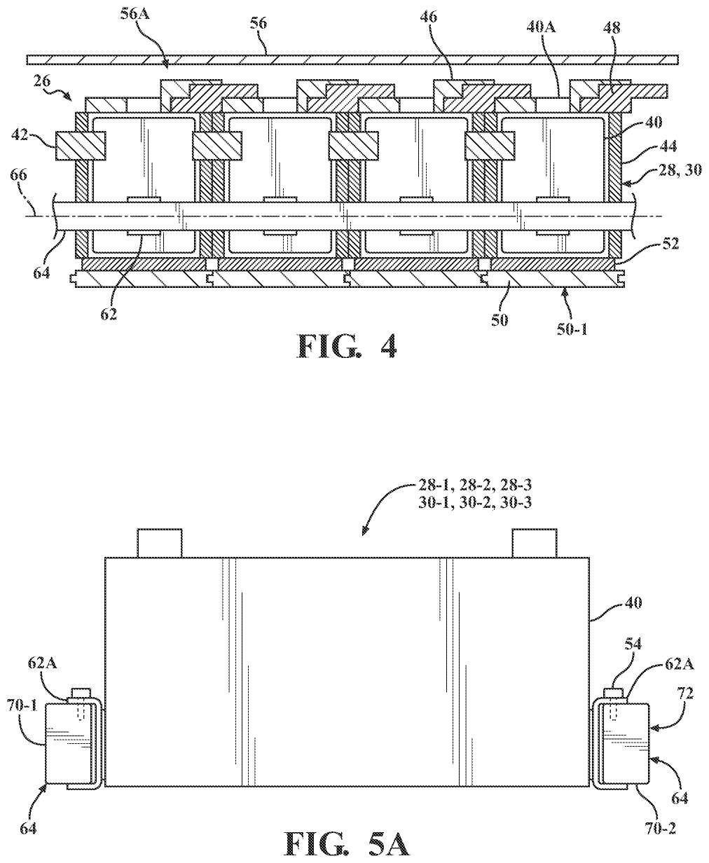

In addition to the constituent battery cell blocks being interlocked and functionally connected in the array 26, the resultant battery chain is mounted to the RESS enclosure 32 at each cell case 40. As shown in FIG. 4, each cell case 40 includes at least one interface connector 62 that may be engaged by one or more fasteners 54. The fastener(s) 54 may be bolts (shown in FIG. 5A), clamps (shown in FIG. 5B), welds, etc. As also shown in FIG. 4, the RESS enclosure 32 also includes a rail structure 64 arranged along a RESS rail axis 66. Each of the interface connectors 62 is configured to link or couple the respective cell case 40 to the rail structure 64. The engagement between the cell case 40 and the rail structure 64 via the interface connector(s) 62 aligns and supports the corresponding battery cell block by the rail structure and may facilitate substantially linear slidable movement of the cell block along the rail axis 66. Accordingly, each cell block in the respective cell groups 28, 30 is engaged with, as well as aligned and supported by the rail structure 64.

The rail structure 64 may be mounted to the enclosure tray 36 and/or to the enclosure cover 38 via appropriate fastening means 68 (shown in FIG. 2), such as bolts, interlocking features, welds, or epoxy. Each battery cell block in cell groups 28, 30 is electrically insulated from the rail structure 64. For example, the interface connectors 62 may be constructed from an electrically nonconductive material that is also relatively rigid and heat resistant. Such cell case material may be a polymer, such as acrylonitrile butadiene styrene (ABS) plastic. Such polymer components may be molded, machined, or 3D printed to achieve the desired shape. In another embodiment, the interface connectors 62 may be constructed from metal, such as Al 3000, with e-coating, spray coating, or insulation film applied for electrical insulation between the battery cell case 40 and the rail structure 64.

As shown in FIGS. 5A-5E, the rail structure 64 may include one or more guide rails extending along the rail axis 66. In the embodiment having a plurality of guide rails, such as a first rail 70-1 and a second rail 70-2, the subject guide rails extend parallel to the rail axis 66 and to each other. Although not shown, the subject guide rails may be configured as upper beams adjacent to the enclosure cover 38, lower beams arranged adjacent to the enclosure tray 36, or side beams mounted proximate an interface between the cover and the tray. Upper beam(s) adjacent to the enclosure cover 38 (not shown) may be used to further enhance stability of cell groups 28, 30, such as in the embodiment of the rail structure 64 arranged lower in the RESS enclosure 32, adjacent to the enclosure tray 36. As shown in FIG. 5A, in a cross-sectional view, each of the guide rails may have an external, convex rail surface 72. Alternatively, as shown in FIGS. 5C and 5D, in a cross-sectional view, each of the parallel guide rails may have an internal, concave rail surface 74. As shown in FIG. 5A, each guide rail 70-1, 70-2 may be a distinct component mounted to the corresponding enclosure tray 36 or cover 38, or, as shown in FIG. 5C, be formed into, such as stamped or cast therewith.

Individual interface connectors 62 may have a U-shaped or C-shaped cross-section 62A (shown in FIG. 5A) the external rail surface 72 or L-shaped cross-section 62B (shown in FIG. 5B) configured to slidably engage one of the parallel guide rails, e.g., 70-1, 70-2. Alternatively, individual interface connectors 62 in the embodiment of FIGS. 5C and 5D may be structured as respective protrusions 62C or 62D configured to slidably engage the internal rail surface 74 of one of the parallel guide rails, e.g., 70-1, 70-2. The protrusions 62C shown in FIG. 5C may have a rigid structure. On the other hand, the protrusions 62D shown in FIG. 5D may have a resilient or spring-like structure, for example with an expanding mushroom shape enabling the subject interface connectors 62 to be snapped into the internal rail surface 74. The resilient protrusion structure 62C or 62D may be incorporated into a bottom section of the cell case 40 and configured to be fit or snapped into the internal rail surface 74 for mounting the respective cell block thereon. As shown in the embodiment of FIG. 5D, alternatively, or in addition to the resilient structure 62D interface connectors, the internal rail surface 74 may itself be characterized by a resilient, i.e., spring-like, structure configured to accept the interface connectors of individual cell blocks. In each of the embodiments of FIGS. 5A-5D, the corresponding battery cell blocks 28-1, 28-2, 28-3 or 30-1, 30-2, 30-3 may be shifted along the rail axis 66 via the interface connectors 62 prior to being interlocked with adjacent cell blocks and set in place.

With reference to FIG. 5E, each battery cell block 28-1, 28-2, 28-3 or 30-1, 30-2, 30-3 may additionally include interconnecting flange(s) 76-1, 76-2 mounted, e.g., welded, to the cell case 40. Each flange 76-1, 76-2 is configured to interlock with a neighboring flange of an adjacent cell block to thereby generate a chain connection between cell blocks in a respective group 28, 30 and/or array 26. For example, as shown in FIG. 5E, the negative side of each cell block may have a stepped flange 76-1, while the positive side of the cell block may have a mating flange 76-2 configured to be captured by the stepped flange. The battery cell blocks interconnected in respective cell groups 28, 30 via the subject flanges may be removed individually or as a group from the RESS housing 32 in a direction perpendicular to the rail axis 66 out of the RESS tray 36, such as along the Z-axis shown in FIG. 1. The flanges 76-1, 76-2 may also be fixed to each other in the respective groups 28, 30, such as via welds 77. The flanges 76-1 and/or 76-2 may incorporate interface connectors 62E coupling the cell case 40 to the rail structure 64, and further secured via the fastener(s) 54.

The rail structure 64 may define individual parallel slots 64A arranged at predefined intervals and configured to accept interface connectors 62 of the respective battery cell blocks 28-1, 28-2, 28-3 or 30-1, 30-2, 30-3 for insertion thereof along the Z axis into individual rails, e.g., 70-1, 70-2. Although not shown, the interface connectors 62 may be either configured as brackets affixed to the cell case 40, or be integrally formed cell case features, such as stamped or cast therewith. As shown in FIG. 5D, the guide rails may define a plurality of apertures 78 configured to accept the fasteners 54. The fasteners 54 may extend through the apertures 78 and the complementary apertures 80 in the interface connectors 62, such as shown with respect to the connector embodiment 62C in FIG. 5C, to fix the corresponding battery cell case 40 to the guide rails. The apertures 78 may be arranged at regular intervals, thereby defining positioning of individual battery cells within the RESS enclosure 32. The fastened battery cell blocks may be easily removed and replaced in the assembled RESS 24, such as in the event an individual battery cell degrades or fails. This permits individual battery cells to be retrofitted and RESS 24 to be refurbished in the field with minimal disassembly and, in some embodiments, without necessitating removal of the RESS from the vehicle 10.

As shown in FIG. 5D, one or more fluid conduits 82 may be incorporated into the rail structure 64. The conduit(s) 82 may be in fluid communication with a coolant manifold (not shown) and be supplied via the subject manifold with a coolant using a fluid pump external to the RESS 24. When the battery cell blocks are interconnected into cell groups 28 and 30, as shown in FIG. 3, the cold plate segments 50 of the constituent cell blocks form a cold plate subassembly 50A configured to absorb thermal energy and maintain requisite RESS 24 operating conditions. The resultant cold plate subassembly 50A may be connected to the conduit(s) 82 to receive and circulate the coolant for removing thermal energy from the respective cell array 26.

Overall, modular assembly of RESS arrays 26 is facilitated by interlocking battery cell blocks being mounted to the rail structure 64 via individual interface connectors 62. The battery cell blocks are coupled with the rail structure 64 via interface connectors 62. Thus, aligned and supported, the battery cell blocks may then be positioned and functionally and mechanically interlocked with adjacent cell blocks and fixed to the rail structure 64 via appropriate fastening means. Cell arrays composed of interlocked battery cell blocks provide the modular RESS 24 with enhanced rigidity, which may be useful when the RESS is incorporated into its host environment, such as a vehicle body structure. The individual battery cell blocks may also be disconnected from one another, removed, and replaced, permitting the RESS 24 to be efficiently retrofitted with new battery cells.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A modular multi-cell rechargeable energy storage system (RESS) comprising:
a RESS enclosure surrounded by an external environment and having an enclosure tray, an enclosure cover, and a rail structure; and
a plurality of interconnected battery cell blocks arranged in the RESS enclosure;
wherein each battery cell block includes a cell case having at least one interface connector configured to couple the cell case to the rail structure, such that each battery cell block is engaged with and aligned and supported by the rail structure.

2. The modular RESS of claim 1, wherein the rail structure is mounted to at least one of the enclosure tray and the enclosure cover.

3. The modular RESS of claim 1, wherein the rail structure includes a plurality of parallel guide rails.

4. The modular RESS of claim 3, wherein the at least one interface connector is configured to slidably engage the parallel guide rails.

5. The modular RESS of claim 3, wherein, in a cross-sectional view, each of the parallel guide rails has a convex rail surface.

6. The modular RESS of claim 3, wherein, in a cross-sectional view, each of the parallel guide rails has a concave rail surface.

7. The modular RESS of claim 6, wherein each interface connector is a protrusion configured to slidably engage the concave rail surface of one of the parallel guide rails.

8. The modular RESS of claim 7, wherein the protrusion is configured to snap into the concave rail surface.

9. The modular RESS of claim 1, wherein each interface connector is one of an integrally formed feature of the cell case and a bracket affixed thereto.

10. The modular RESS of claim 1, wherein each battery cell block additionally includes interlocking flanges mounted to the cell case and configured to interconnect adjacent cell blocks, and wherein at least one of the interlocking flanges of each battery cell block incorporates the interface connector to couple the cell case to the rail structure.

11. A motor vehicle comprising:
a power-source configured to generate power-source torque;
a vehicle body structure incorporating, as part thereof, a modular multi-cell rechargeable energy storage system (RESS) configured to supply electrical energy to the power-source, the modular RESS including:
a RESS enclosure surrounded by an external environment, integrated into the vehicle body structure, and having an enclosure tray, an enclosure cover, and a rail structure; and
a plurality of interconnected battery cell blocks arranged in the RESS enclosure;
wherein each battery cell block includes a cell case having at least one interface connector configured to couple the cell case to the rail structure, such that each battery cell block is engaged with and aligned and supported by the rail structure.

12. The motor vehicle of claim 11, wherein the rail structure is mounted to at least one of the enclosure tray and the enclosure cover.

13. The motor vehicle of claim 11, wherein the rail structure includes a plurality of parallel guide rails.

14. The motor vehicle of claim 13, wherein the at least one interface connector is configured to slidably engage the parallel guide rails.

15. The motor vehicle of claim 13, wherein, in a cross-sectional view, each of the parallel guide rails has a convex rail surface.

16. The motor vehicle of claim 13, wherein, in a cross-sectional view, each of the parallel guide rails has a concave rail surface.

17. The motor vehicle of claim 16, wherein each interface connector is a protrusion configured to slidably engage the concave rail surface of one of the parallel guide rails.

18. The motor vehicle of claim 17, wherein the protrusion is configured to snap into the concave rail surface.

19. The motor vehicle of claim 11, wherein each battery cell block additionally includes interlocking flanges mounted to the cell case and configured to interconnect adjacent cell blocks, and wherein at least one of the interlocking flanges of each battery cell block incorporates the interface connector to couple the cell case to the rail structure.

20. A modular multi-cell rechargeable energy storage system (RESS) comprising:
a RESS enclosure surrounded by an external environment and having an enclosure tray, an enclosure cover, and a rail structure; and
a plurality of interconnected battery cell blocks arranged in the RESS enclosure, wherein:
each battery cell block includes a cell case having at least one interface connector configured to slidably couple the cell case to the rail structure, such that each battery cell block is engaged with and aligned and supported by the rail structure;
the rail structure is mounted to at least one of the enclosure tray and the enclosure cover and includes a plurality of parallel guide rails; and
each interface connector is one of an integrally formed feature of the cell case and a bracket affixed thereto.
